(19) United States
(12) Patent Application Publication
(10) Pub. No.: US 2010/0158651 A1
(43) Pub. Date: Jun. 24, 2010

(54) Silo with reciprocating frame having blanking plate

(75) Inventors: Thomas M. Anderson, Naples, FL (US); Charles Wanstrom, Maplewood, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Schwing Bioset, Inc., Somerset, WI (US)

(21) Appl. No.: 12/317,465

(22) Filed: Dec. 23, 2008

(51) Int. Cl. B65G 65/30

(52) U.S. Cl. 414/306; 414/808

(57) ABSTRACT

A silo with a reciprocating frame includes a blanking plate that is capable of limiting the amount of material released from the silo. A blanking plate is attached to at least one reciprocating frame and is configured to substantially cover an opening in a floor when the reciprocating frame is centered above the opening in the floor.

### BACKGROUND

The present invention relates generally to a method and a device for discharging material from a silo. More specifically, the present invention relates to a silo having a reciprocating frame.

Silos are large receptacles used to store and discharge materials. Silos usually have an inlet at the top and an outlet at the bottom. Virtually any type of material may be placed into a silo and later discharged. Viscous wet materials, however, are difficult to discharge because they are not free-flowing. For example, municipal waste sludge stored in silos tends to clump together and form bridges over a discharge opening. Discharge devices may be incorporated into the bottom of a silo above a discharge opening to dislodge material bridges and induce sludge flow.

Several types of discharge devices for coaxing sludge out of silos are known. In rectangular and square silos, the push floor design is common. The push floor consists of a series of hydraulically driven ladders that move linearly to convey sludge toward a discharge opening. In circular or polygonal silos, rotating scrapers or movable frames may be incorporated near the silo floor. In the case of rotating scrapers, radial arms extending from a central body include rotating or oscillating scrapers that break up clumps of sludge. In the case of movable frames, an open frame structure reciprocates back and forth over the silo floor pushing and pulling sludge along with it and over a discharge opening. While inclusion of a discharge device near the floor of a silo is known, the construction and operation of such discharge devices are far from ideal.

### SUMMARY

An exemplary embodiment of the present invention is a silo including an exterior wall and a floor attached to the exterior wall. An opening is located in the floor for discharging materials from the silo. At least one reciprocating frame is located immediately above and parallel to the floor. A hydraulic system is connected to the reciprocating frame for actuating the reciprocating frame across the floor of the silo. A blanking plate is attached to the reciprocating frame and is configured to cover at least a portion of the opening when located above the opening.

In addition, an exemplary embodiment of the invention is a method of servicing a silo having a reciprocating frame. First, normal operation of a silo having a reciprocating frame is halted. Second, the reciprocating frame is placed in an intermediate position where a blanking plate attached to the frame substantially covers an opening in the floor. Third, silo components are serviced.

### BRIEF DESCRIPTION OF THE DRAWINGS

FIG. 1 is a perspective view of a silo having a reciprocating frame in accordance with the present invention.

FIG. 2 is a top view of the inside of the silo from FIG. 1 with the reciprocating frame in a first, fully retracted position.

FIG. 3 is a top view of the inside of the silo with the reciprocating frame in a second, fully extended position.

FIG. 4 is a top view of the inside of the silo with the reciprocating frame in a third, intermediate position.

FIG. 5 is a detailed top view of a reciprocating frame.

FIG. 6A is a side elevation and FIG. 6B is a front elevation of the reciprocating frame from FIG. 5.

FIG. 7 is a top view of an alternative embodiment having a plurality of reciprocating frames.

FIG. 8 is a diagram of a method of limiting material released from a silo.

### DETAILED DESCRIPTION

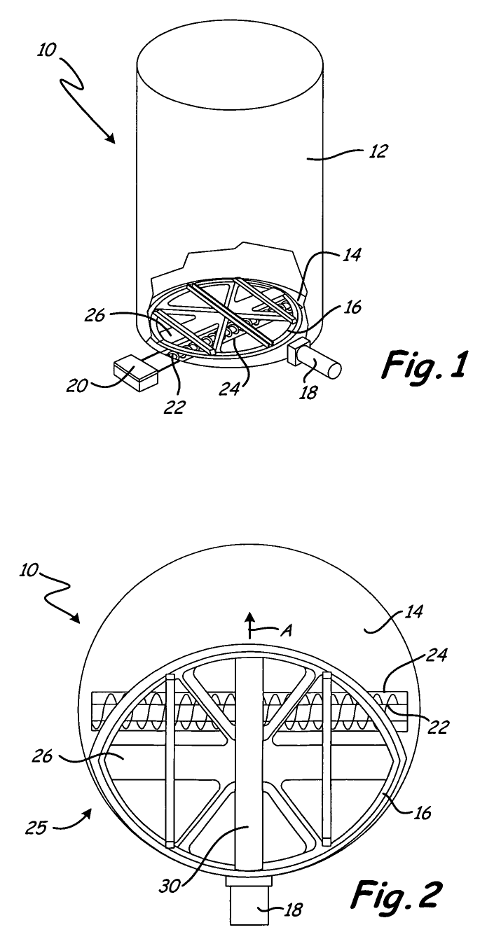

FIG. 1 is a perspective view of silo 10 with a portion of exterior wall 12 broken away to expose floor 14 and reciprocating frame 16. Also visible are hydraulic system 18, outlet 20, screw conveyor 22, opening 24, and blanking plate 26.

Silo 10 includes exterior wall 12 attached to floor 14. In the depicted embodiment, exterior wall 12 forms an upstanding cylinder resting on top of circular floor 14. In alternative embodiments, exterior wall 12 forms an upstanding rectangle resting on top of rectangular floor 14. At least one reciprocating frame 16 is located within silo 10 immediately above and parallel to floor 14. Reciprocating frame 16 is an open structure attached to hydraulic system 18, which extends beyond exterior wall 12. Outlet 20 is also exterior to exterior wall 12 and is connected to screw conveyor 22. Screw conveyor 22 is located beneath opening 24. In the depicted embodiment, opening 24 is an elongated rectangle which extends across a chord of circular floor 14. Attached to a center of reciprocating frame 16 is blanking plate 26 for limiting material released through opening 24 to screw conveyor 22.

Material is generally stored within silo 10 to be discharged at a later time. Usually, material is placed into silo 10 through an opening in a top of silo 10, although other configurations are known. Gravity causes material placed in silo 10 to accumulate near floor 14. All sorts of materials may be stored in silo 10, including dry materials, wet materials, or sludge-like combinations of wet and dry materials. When the material is highly viscous, it tends to resist natural gravitational flow. In at least this instance, it is desirable to include at least one reciprocating frame 16 near floor 14 to mechanically induce flow in the viscous material. Reciprocating frame 16 is attached to hydraulic system 18, which actuates reciprocating frame 16 across floor 14. The resulting back and forth movement of reciprocating frame 16 breaks up cohesive masses while pushing and pulling the material toward opening 24 in floor 14. Beneath opening 24 in floor 14 is at least one screw conveyor 22. Material falls through opening 24 and onto screw conveyor 22, which may include a rotating screw auger and/or a means for metering material. Screw conveyor 22 then discharges material from silo 10 via outlet 20. Discharged material may be picked up and transported to another location.

When parts of silo 10 below floor 14 need servicing (such as screw conveyor 22), reciprocating frame 16 may be centered above opening 24 such that blanking plate 26 attached to a center of reciprocating frame 16 substantially covers opening 24. By covering opening 24, blanking plate 26 blocks material from exiting silo 10. While some material may flow around blanking plate 26 and leak through opening 24, the amount of material discharged will be significantly reduced thereby allowing for easier servicing of silo 10 parts below floor 14.

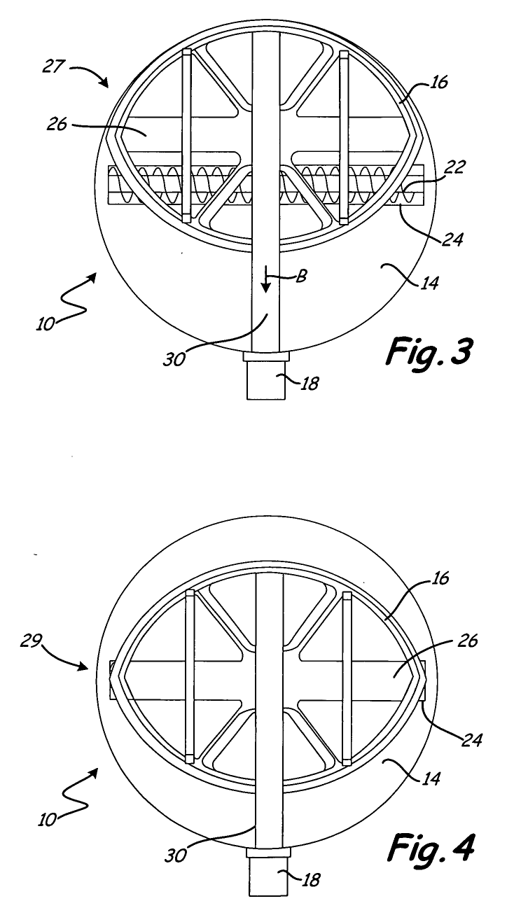

FIGS. 2, 3, and 4 depict the movement of reciprocating frame 16 across floor 14. FIG. 2 is a top view of the inside of silo 10 with reciprocating frame 16 in first, fully retracted position 25. FIG. 3 is a top view of the inside of silo 10 with reciprocating frame 16 in second, fully extended position 27. FIG. 4 is a top view of the inside of silo 10 with reciprocating frame 16 in third, central position 29. Also visible in FIGS. 2, 3, and 4 are hydraulic system 18, screw conveyor 22, opening 24, blanking plate 26, and pushrod 30.

Reciprocating frame 16 is connected to hydraulic system 18 via pushrod 30. In FIG. 2, reciprocating frame 16 is resting in first, fully retracted position 25. Once activated, hydraulic system 18 drives pushrod 30 further into silo 10, which actuates reciprocating frame 16 across floor 14 in direction A. Reciprocating frame 16 leaves first position 25 pushing and pulling material toward opening 24 in floor 14, encouraging material to fall through opening 24 onto screw conveyor 22. Reciprocating frame 16 will continue across floor 14 in direction A until pushrod 30 reaches full extension, or until an obstruction prevents further movement.

If no obstruction is encountered and hydraulic system 18 remains activated, reciprocating frame 16 will reach second, fully extended position 27 on an opposite end of silo 10, which is depicted in FIG. 3. Reciprocating frame 16 will move across floor 14 once between occupying first position 24 and occupying second position 26. In second position 27, reciprocating frame 16 is remote from hydraulic system 18 and pushrod 30 is fully extended. Pushrod 30 is capable of retracting and actuating reciprocating frame 16 back across floor 14 in direction B. Reciprocating frame 16 leaves second position 27 pushing and pulling material toward opening 24 in floor 14, once again encouraging material to fall through opening 24 onto screw conveyor 22. If no obstruction is encountered and hydraulic system 18 remains activated, pushrod 30 will retract until reciprocating frame 16 has returned to first position 25. Both first and second positions 25 27 may include limit sensors for communicating that reciprocating frame 16 has reached first and second positions 25 27. The resulting movement of reciprocating frame 16 between first position 25 and second position 27 agitates viscous material and coaxes material to fall through opening 24 onto screw conveyor 22 for discharge from silo 10.

FIG. 4 depicts reciprocating frame 16 in a third, intermediate position 29. Third position.29 is located in an approximate center of silo 10 halfway between first position 25 and second position 27. In third position 29, pushrod 30 is partially, but not fully extended. Third position 29 may also include a limit sensor for communicating that reciprocating frame has reached third position 29. Blanking plate 26 is centered directly above opening 24 which, in the depicted embodiment, extends across a chord of floor 14. When reciprocating frame occupies third position 29, the material released through opening 24 onto screw conveyer 22 is substantially reduced, thereby simplifying maintenance operations on parts located beneath silo 10, such as but not limited to, screw conveyor 22.

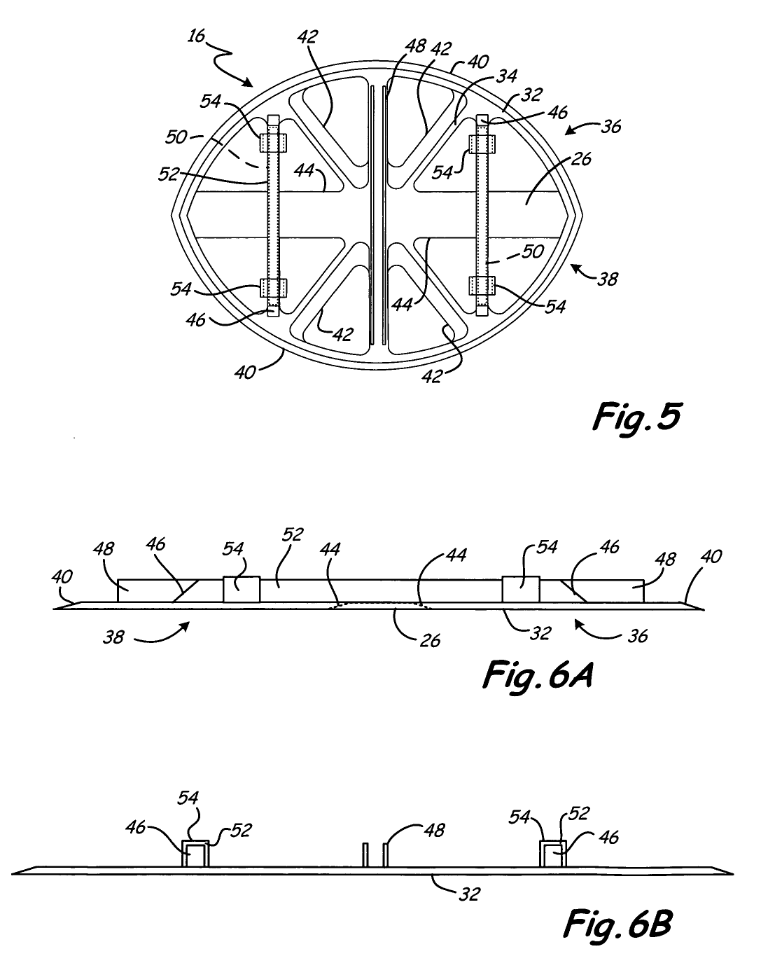

FIG. 5 is detailed top view of one embodiment of reciprocating frame 16 including blanking plate 26, perimeter 32, and center scraper 34. For descriptive purposes, reciprocating frame 16 is divided into first half 36 and second half 38. Rim 32 has first bevel 40 and center scraper 34 has second bevel 42. Also visible are plate bevels 44, tube bevels 46, bars 48, support members 50, tubes 52, and hold-down plates 54.

Reciprocating frame 16 has perimeter 32, which is an outer rim portion containing center scraper 34 and blanking plate 26. In the depicted embodiment, perimeter 32 is shaped like an ellipse or a football. Center scraper 34 is shaped like the letter “X” and extends across a minor axis of perimeter 32, while blanking plate 26 is shaped like an elongated rectangle and extends across a major axis of perimeter 32. The shape of perimeter 32, center scraper 34, and blanking plate 26 is dependant on a multitude of factors such as silo size, the location of an opening in the floor, the size of the opening in the floor, and the type of materials to be stored in a silo. Perimeter 32, center scraper 34, and blanking plate 26 are capable of assuming alternate shapes while achieving the objectives outlined below.

Blanking plate 26 is attached to perimeter 32 and center scraper 34. Blanking plate 26 extends across an x-axis of perimeter 32 so that when reciprocating frame 16 assumes a central position within a silo, blanking plate 26 is located above an opening in a floor. Plate bevels 44 running along first half 36 of blanking plate 26 and second half 38 of blanking plate 26 reduce friction between blanking plate 26 and material within a silo. Plate bevels may be beveled at an angle between approximately 1 and 45 degrees, although any acute angle is within the scope of this invention. Blanking plate 26 may be comprised of metal, such as but not limited to, carbon steel.

Center scraper 36 extends across a y-axis of perimeter 32 so that first half 36 of center scraper 34 is attached to an inside surface of first half 36 of perimeter 34, and a second half 38 of center scraper 34 is attached to an inside surface of second half 38 of perimeter 32. Perimeter 32 has first bevel 40 located along an outer surface and center scraper 34 has second bevel 42 located on an outer surface to reduce friction between reciprocating frame 16 and material within a silo. In one embodiment, first bevel 40 and second bevel 42 have approximately equal angles of between approximately 1 and 45 degrees, although any acute angle is within the scope of the present invention. First bevel 40 and second bevel 42 may be machined from a metal, such as carbon steel, or the bevels may include composite material in order to reduce the manufacturing cost and/or coefficient of friction for the bevels.

Bars 48 extend substantially across a y-axis of perimeter 32 and are centrally located within both perimeter 32 and center scraper 34. First half 36 of bars 48 extend toward first half 36 of perimeter 32 and second half 38 of bars 48 extend toward second half 38 of perimeter 32. A plurality of support members 50 are also located within perimeter 32. Support members 50 run parallel to bars 48 and extend substantially across the y-axis of perimeter 32, but are located on either side of center scraper 34. First half 36 of support members 50 extend toward first half 36 of perimeter 32 and second half 38 of support members 50 extend toward second half 38 of perimeter 32. Tubes 52 are located on top of, run the length of, and attach to, support members 50. Tubes 52 are rectangular and have tube bevels 46 located on closed ends of tubes 52 to reduce friction between tubes 52 and material within a silo. Tubes 52 may extend through, and be surrounded by, one or more hold-down plates 54. Each hold-down plate 54 is shaped like an upside down letter “U”, which is capable of surrounding a tube 52 and attaching to a floor of a silo to prevent the reciprocating frame from drifting.

As described above with reference to FIGS. 2 and 3, reciprocating frame 16 is capable of bi-directional movement across a floor of a silo. As described above with reference to FIG. 4, reciprocating frame 16 may be stopped in a third, intermediate position where blanking plate 26 substantially covers an opening in silo floor. Blanking plate 26 is capable of reducing material flow to a conveyor located beneath an opening in a floor so that components beneath the floor may be easily serviced.

First bevel 40 and second bevel 42, as well as plate bevels 44 and tube bevels 46, all function to reduce friction between reciprocating frame 16 and material within a silo. Bars 48 are configured to attach reciprocating frame 16 to a pushrod of a hydraulic system. Support members 50 are configured to help maintain the shape of reciprocating frame 16, as well as support tubes 52. Tubes 52 are configured to cooperate with hold-down plates 54 to keep reciprocating frame 16 from floating upwards or over to one side. As reciprocating frame 16 moves from a first position to a second position, tubes 52 slide through one or more hold-down plates 54 thereby keeping reciprocating frame 16 adjacent a floor of a silo.

FIG. 6A is a side elevation and FIG. 6B is a front elevation of reciprocating frame 16 showing perimeter 32, first half 36, second half 38, first bevel 40, plates bevels 44, tube bevels 46, bars 48, tubes 52, and hold-down plates 54. Perimeter 32 has first bevel 40, blanking plate 26 has beveled plate bevels 44, and tubes 52 have tube bevels 46. Bars 48 are centrally located in perimeter 32 and extend upwards to attach to a push-rod. Tubes 52 are located on either side of bars 48 and also extend upwards to cooperate with hold-down plates 54. Hold-down plates 54 extend around tubes 52 and attach to a floor of a silo beneath reciprocating frame 16 to hold the reciprocating frame 16 in place.

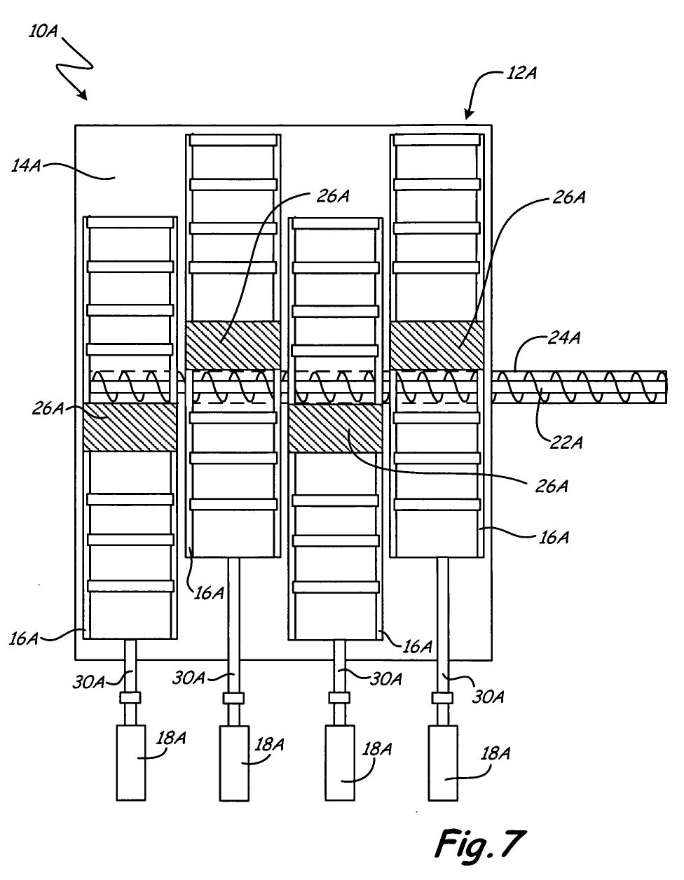

FIG. 7 is a top view of an alternative embodiment of the present invention having a plurality of reciprocating frames 16A. Illustrated in FIG. 7 are silo 10A, exterior wall 12A, floor 14A, reciprocating frames 16A, hydraulic cylinders 18A, screw conveyor 22A, opening 24A, blanking plates 26A, and push-rods 30A. The components of silo 10A are substantially similar to the components of silo 10 described above. The discussion below focuses on the differences between silo 10 and silo 10A, namely, the number and shape of reciprocating frames 16A.

Silo 10A is defined by upstanding exterior wall 12A resting on top of rectangular floor 14A. In the depicted embodiment, four reciprocating frames 16A are located immediately above and parallel to floor 14A, although more or less reciprocating frames 16A are equally possible. Reciprocating frames 16A are attached to, and actuated by, hydraulic cylinders 18A. Screw conveyor 22A is located beneath opening 24A in floor 14A. Attached to each reciprocating frame 16A is blanking plate 26A. In the depicted embodiment, screw conveyor 22A, opening 24A, and blanking plates 26A are all centrally located, although they can be offset to one side or another. Connecting reciprocating frames 16A to hydraulic cylinders 18A are push-rods 30A.

Reciprocating frames 16A operate in much the same manner as reciprocating frame 16 described above. Hydraulic cylinders 18A extend and retract push-rods 30, which actuate reciprocating frames 16A across floor 14A. As pushrods 30A extend further into silo 10A, reciprocating frames 16A are moved to a position remote from hydraulic cylinders 18A. As pushrods 30A retract back out of silo 10A, reciprocating frames 16A are moved to a position adjacent hydraulic cylinders 18A. In the depicted embodiment, reciprocating frames 16A are staggered so that as one moves away from hydraulic cylinder 18A the neighboring reciprocating frame 16A is moves closer to hydraulic cylinder 18A. When reciprocating frames 16A move across floor 14A, material within silo 10A is pushed and pulled toward opening 24A such that it can fall through opening 24A onto screw conveyor 22A. Blanking plates 26A located on reciprocating frames 16A are capable of lining up over opening 24A and forming a substantially blanking plate 26A. Thus, blanking plates 26A stop silo material from falling through opening 24A so that screw 22A or other components located beneath floor 14A can be serviced. If screw 22A and opening 24A are offset to one side or another of silo 10A, then blanking plates 26A are also offset. Screw 22A, opening 24A, and blanking plates 26A need not be centrally located in order to perform their intended functions. The only requirement of blanking plates 26A is that they be capable of stopping in an intermediate position where they substantially cover opening 24A in floor 14A.

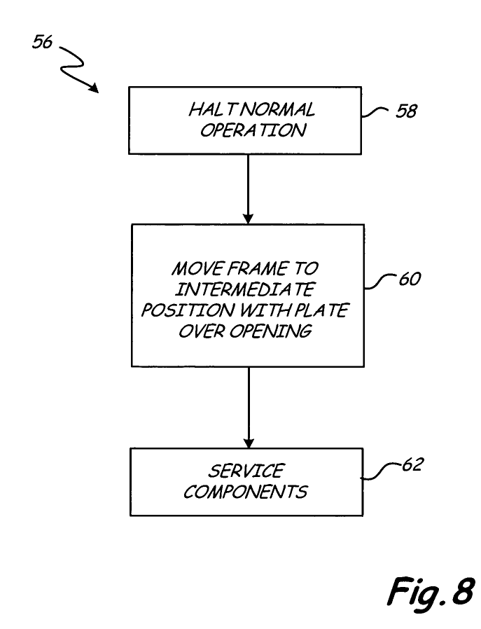

FIG. 8 is a diagram of method 56 of servicing a silo having a reciprocating frame. Method 56 includes halting normal operation of a silo having a reciprocating frame 58, placing the reciprocating frame in an intermediate position where a blanking plate attached to the frame substantially covers an opening in a floor 60, and servicing silo components located below the floor 62.

In a silo having a reciprocating frame, normal operation includes actuation of reciprocating frame across a floor of the silo by a hydraulic system. Should any of the components beneath the floor of the silo need servicing, a method of servicing a silo having a reciprocating frame 56 should be initiated. To begin, normal operation of the silo having a reciprocating frame is halted 58. Normal operation includes the reciprocating frame being actuated or stopped anywhere in its path along the silo floor. Next, the reciprocating frame is placed in an intermediate position where a blanking plate attached to the frame substantially covers an opening in the floor 60. In this intermediate position, the blanking plate substantially blocks material from flowing through the opening in the floor onto a conveyor located beneath the floor. Components located below the floor may then be serviced 62 without constant bombardment of material flowing through the opening in the floor.

Although the present invention has been described with reference to preferred embodiments, workers skilled in the art will recognize that changes may be made in form and detail without departing from the spirit and scope of the invention.

1. A silo comprising:
an exterior wall;
a floor attached to the exterior wall;
an opening located in the floor for discharging materials from the silo;
at least one reciprocating frame located immediately above and parallel to the floor;
a hydraulic system connected to the reciprocating frame for actuating the reciprocating frame across the floor of the silo; and
a blanking plate attached to the reciprocating frame and configured to cover at least a portion of the opening when located above the opening.

2. The silo of claim 1, wherein the blanking plate is wider than the opening.

3. The silo of claim 2, wherein the blanking plate has at least one beveled surface.

4. The silo of claim 1 wherein the blanking plate is generally rectangular.

5. The silo of claim 4, wherein the blanking plate is located in an approximate center of the reciprocating frame.

6. The silo of claim 1, wherein the blanking plate comprises metal.

7. The silo of claim 6, wherein the blanking plate comprises carbon steel.

8. The silo of claim 1, wherein the reciprocating frame has at least one beveled surface.

9. The silo of claim 1, wherein the floor is rectangular.

10. The silo of claim 9, wherein the reciprocating frame is a plurality of rectangular reciprocating frame units.

11. The silo of claim 1, wherein the floor is circular.

12. The silo of claim 11, wherein the reciprocating frame is elliptical.

13. The silo of claim 12, wherein the opening is located along a chord of the circular floor.

14. The silo of claim 13, wherein the reciprocating frame includes a center scraper.

15. The silo of claim 14, wherein the reciprocating frame includes a rim and support members extending across the rim.

16. A method of servicing a silo having a reciprocating frame, the method comprising:
halting normal operation of a silo having a reciprocating frame;
placing the reciprocating frame in an intermediate position where a blanking plate attached to the frame substantially covers an opening in a floor; and
servicing silo components located below the floor.

17. The method of claim 16, wherein placing the reciprocating frame in an intermediate position where a blanking plate attached to the frame substantially covers an opening in a floor limits material release through the opening in the floor.

18. The method of claim 16, wherein placing the reciprocating frame in an intermediate position where a blanking plate attached to the frame substantially covers an opening in a floor includes covering a screw conveyor located beneath the opening in the floor.

19. The method of claim 18, wherein servicing silo components includes servicing the screw conveyor.

20. The method of claim 16, wherein the blanking plate is attached to an approximate center of the reciprocating frame.
